(19) United States
(12) Patent Application Publication
(10) Pub. No.: US 2026/0267443 A1
(43) Pub. Date: Sep. 10, 2026

(54) DETERMINATION DEVICE, DETERMINATION METHOD, AND DETERMINATION PROGRAM

(71) Applicant: Renesas Electronics Corporation, Tokyo (JP)

(72) Inventor: Eiji YAMANAKA, Tokyo (JP)

(73) Assignee: Renesas Electronics Corporation, Tokyo (JP)

(21) Appl. No.: 19/558,715

(22) Filed: Mar. 6, 2026

(30) Foreign Application Priority Data
Mar. 7, 2025 (JP) 2025-036394

(51) Int. Cl. G06F 3/041; G06F 3/044

(52) U.S. Cl. CPC G06F 3/0418; G06F 3/044; G06F 2203/04108

(57) ABSTRACT

A determination device, a determination method and a determination program each capable of accurately making determination are provided. The determination device includes: a first filter configured to perform a first filter processing to a measurement value measured by a sensor, based on a first filter property; a first determination section configured to determine a detection state of the sensor by comparing a measurement value subjected to the first filter processing with a first threshold; a second filter configured to perform a second filter processing to the measurement value, based on a second filter property; a second determination section configured to determine a detection state of the sensor by comparing a measurement value subjected to the second filter processing with a second threshold; and an output section configured to output a determination result of the first determination section or a determination result of the second determination section.

### CROSS-REFERENCE TO RELATED APPLICATION

The disclosure claims priority to Japanese Patent Application No. 2025-036394 filed on Mar. 7, 2025, including the specification, drawings and abstract and is incorporated herein by reference for all purposes.

### BACKGROUND

The present disclosure relates to a determination device, a determination method, and a determination program, and is suitably applicable to, for example, a determination device, a determination method, and a determination program for determining a measurement value of a sensor.

There is disclosed techniques listed below.
[Patent Document 1] Japanese Unexamined Patent Application Publication No. 2015-12377

Various sensors including touch sensors such as touch key and touch screen are used. As a related art, the Patent Document 1 describes a technique of determining presence of touching by measuring a capacitance of a capacitive touch sensor.

### SUMMARY

However, the related-art technique as described in the Patent Document 1 may not achieve the accurate determination, depending on a threshold used for the determination.

Other objects and novel characteristics will become apparent from the description of the present specification and the accompanying drawings.

A determination device according to an embodiment is configured to perform a first filter processing to a measurement value measured by the sensor, based on a first filter property, and to determine a detection state of a sensor by comparing a measurement value subjected to the first filter processing with a first threshold. The determination device is configured to perform a second filter processing to the measurement value measured by the sensor, based on a second filter property, and to determine a detection state of the sensor by comparing a measurement value subjected to the second filter processing with a second threshold. The determination device is configured to output a determination result based on the first threshold or a determination result based on the second threshold.

According to the embodiment, determination can be accurately made.

### BRIEF DESCRIPTION OF THE DRAWINGS

FIG. 1 is a configuration diagram illustrating a schematic configuration of a determination device according to an embodiment.

FIG. 2 is a configuration diagram illustrating an exemplary configuration of a semiconductor device according to a first embodiment.

FIG. 3 is a configuration diagram illustrating an exemplary configuration of a measurement circuit according to the first embodiment.

FIG. 4 is a configuration diagram illustrating an exemplary configuration of a touch determination section according to the first embodiment.

FIG. 5 is a flowchart illustrating an exemplary method for calculating a threshold according to the first embodiment.

FIG. 6 is a diagram for explaining a specific example of the threshold according to the first embodiment.

FIG. 7 is a flowchart illustrating exemplary touch determination according to the first embodiment.

FIG. 8 is a diagram for explaining a specific example of touch determination according to the first embodiment.

### DETAILED DESCRIPTION

Embodiments will be described below with reference to the drawings. Note that the following description and drawings are omitted and simplified as needed for clear explanation. The same components are denoted with the same reference symbols throughout each drawing, and the repetitive description thereof will be omitted as needed.

### Outline of Embodiment

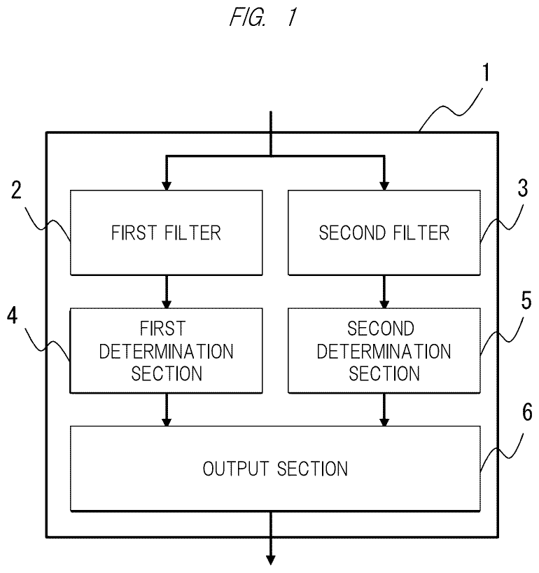

FIG. 1 illustrates a schematic configuration of a determination device 1 according to an embodiment. The determination device 1 is a device that determines a detection state, based on measurement values of various sensors. The sensor may be a touch sensor such as touch key, touch screen, touchless button, 3D gesture sensor, and 2D gesture sensor. The sensor may be not the touch sensor but other sensor. For example, the determination device 1 may be mounted on a semiconductor device or mounted on other apparatus such as an information processor.

In the example of FIG. 1, the determination device 1 includes a first filter 2, a second filter 3, a first determination section 4, a second determination section 5, and an output section 6. In the determination device 1, the numbers of the filter and determination section are not only two, but may be plural.

The first filter 2 and the second filter 3 acquire a measurement value measured by the sensor, and perform a predetermined filter processing to the acquired measurement value. For example, the first filter 2 performs a first filter processing to a measurement value measured by the sensor in accordance with a first filter property. The second filter 3 performs a second filter processing to the measurement value measured by the sensor in accordance with a second filter property. The first filter property of the first filter 2 is different from the second filter property of the second filter 3. That is, the denoising performance of the first filter 2 is different from that of the second filter 3. For example, a window size of a window function of the first filter 2 may be different from a window size of a window function of the second filter 3. The longer the window size is, the larger the denoising performance is, and the larger a delay amount is. The first filter 2 and the second filter 3 are moving average filters, and may be different from each other in a moving average area. The first filter 2 and the second filter 3 may be common with each other in some moving average processings.

The first determination section 4 and the second determination section 5 compare the measurement value processed by the first filter 2 and the second filter 3 with a predetermined threshold, and determine a detection state of the sensor. The detection state of the sensor may be normal or abnormal. For example, if the sensor is a touch sensor, the detection state of the sensor may be a touch state indicating user's touching or a non-touch state indicating that no user's touching.

For example, the first determination section 4 compares a first threshold with the measurement value subjected to the first filter processing by using the first filter 2, and determines the detection state of the sensor. The second determination section 5 compares a second threshold with the measurement value subjected to the second filter processing by using the second filter 2, and determines the detection state of the sensor. The first threshold used by the first determination section 4 is different from the second threshold used by the second determination section 5. That is, the threshold depends on each denoising performance of the filter. For example, when the denoising performance of the second filter 3 is higher than the denoising performance of the first filter 2, the second threshold of the second determination section 5 may be smaller than the first threshold of the first determination section 4. When the window size of the window function of the second filter 3 is longer than the window size of the window function of the first filter 2, the second threshold of the second determination section 5 may be smaller than the first threshold of the first determination section 4. That is, the threshold may be made small to be in reverse proportion to a degree of the denoising performance of the filter. For example, when the window size of the first filter 2 is “n” while the window size of the second filter 3 is “n+m”, the second threshold may be 1/√((n+m)/n) of the first threshold.

The output section 6 outputs the determination result of the first determination section 4 or the determination result of the second determination section 5. The output section 6 outputs either determination result, based on the determination result of the first determination section 4 or the determination result of the second determination section 5. For example, when outputting the determination result of the first determination section 4, the output section 6 may stop outputting the determination result of the second determination section 5. For example, when the first determination section 4 determines that the sensor is in the touch state, the output section 6 may output the determination result of the first determination section 4 and may stop outputting the determination result of the second determination section 5.

As described above, in the embodiment, the plurality of filters with different properties is prepared, and the detection state of the sensor is determined by using the different threshold for each filter. Therefore, the thresholds for determination are appropriately set, thereby improving the determination accuracy.

### First Embodiment

Next, a first embodiment will be described. In the present embodiment, an exemplary touch determination using the touch sensor will be described.

In the case of the touch sensor, a change in parasitic capacitance is measured to detect whether a touch electrode is being touched (is in the touch state or in the non-touch state). The raw data of the measurement value of the capacitance of the touch electrode contains noise, and thus, the noise is to be appropriately removed. A digital filter such as moving average filter is used for removing the noise. In the digital filter, the longer the window side is, the higher the denoising performance is. When the digital filter is the moving average filter, the window size is an average area. For example, when the average area of the moving average filter is “n”, “S/N” is √n times. To the contrary, a too long window size causes a side effect in which a short-period variation cannot be detected, because of increasing the delay amount.

The amount of change in the measurement value is small when the touch electrode is being touched. For example, when a small finger or a dry finger touches the touch electrode, the amount of change may be smaller.

In the related art, the measurement value is compared with the thresholds to make the touch determination, and thus, it is necessary to set appropriate thresholds in order to correctly determine whether the touch electrode is being touched. It is necessary to set the thresholds to be sufficiently larger than the variation due to the noise in order to reduce the erroneous determination due to the noise. To the contrary, if the threshold is too large, a small change may not be detected.

Accordingly, in the present embodiment, the appropriate thresholds are set, thereby achieving the required responsiveness while suppressing the erroneous determination due to the noise.

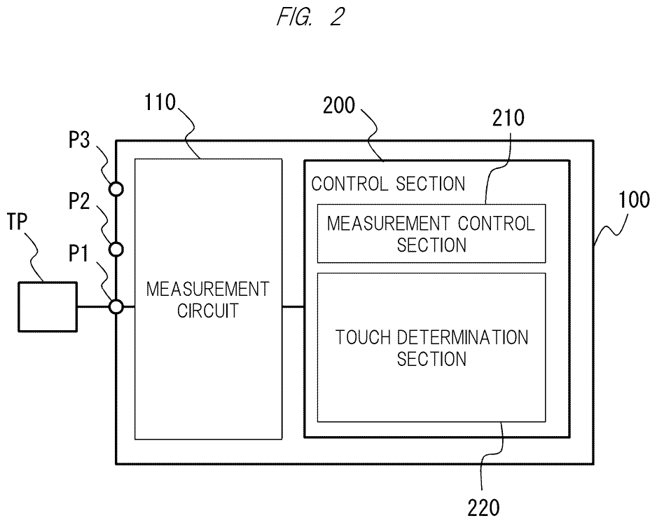

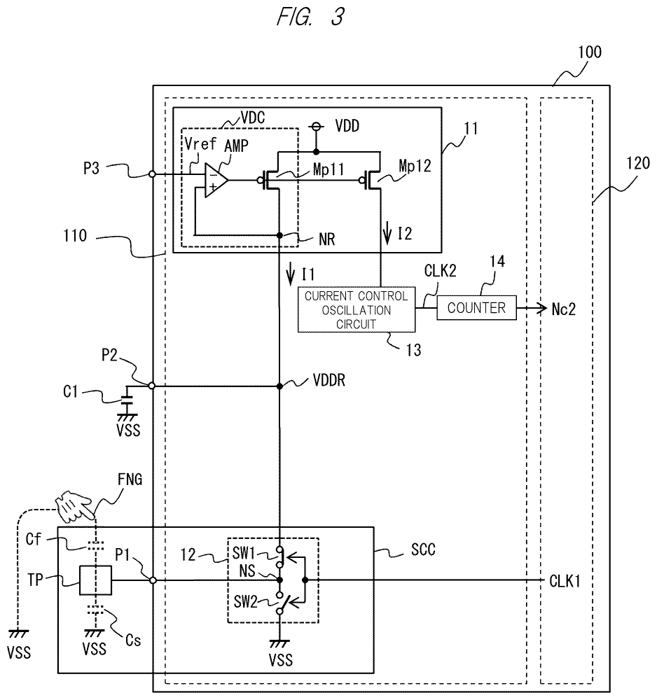

FIG. 2 illustrates an exemplary configuration of a semiconductor device 100 according to the present embodiment. FIG. 3 illustrates an exemplary configuration of a measurement circuit 110 of the semiconductor device 100 of FIG. 2.

The semiconductor device 100 may be, for example, a micro controller unit (MCU) including a capacitive touch sensor circuit. The semiconductor device 100 may be made of a semiconductor device (such as semiconductor chip), the number of which is one or optional. For example, the semiconductor device 100 may be made of a system on chip (SoC).

In the example of FIG. 2, the semiconductor device 100 includes terminals P1 to P3 as external terminals, the measurement circuit 110, and a control section 200. A touch electrode TP is connected to the terminal P1. The touch electrode TP is a self-capacitive touch element as an exemplary capacitive touch element. The touch electrode TP may be, for example, a touch element used for touch key, touch screen, touchless button, 3D gesture sensor, 2D gesture sensor, and the like.

The measurement circuit 110 is a touch sensor circuit for the capacitive touch electrode TP. Specifically, the measurement circuit 110 measures a current corresponding to the capacitance of the touch electrode TP. Note that the measurement circuit 110 may measure the measurement value of not only the touch sensor including the touch electrode but also any sensor. It can be also said that the measurement circuit 110 is a conversion circuit for converting an analog value as the capacitance of the touch electrode TP into a digital value (specifically, a count Nc2 of a counter 14).

The control section 200 makes the touch determination by controlling the measurement operations of the measurement circuit 110, based on the measurement result of the capacitance of the touch electrode TP measured by the measurement circuit 110. The touch determination is to determine whether a user's finger FNG is touching the touch electrode TP (touch state) or is not touching the touch electrode TP (non-touch state). The control section 200 performs the processings required for controlling the measurement circuit 110 and for an application thereof. The application is, for example, a contact or contactless application using touch key, touch screen, touchless button, 3D gesture sensor, 2D gesture sensor, and the like. The function of the control section 200 may be achieved by only hardware, only software, or a combination thereof.

As illustrated in FIG. 2, the control section 200 includes a measurement control section 210 and a touch determination section 220. The measurement control section 210 is a control logic for controlling the measurement operations of the measurement circuit 110. When measuring the capacitance of the touch electrode TP, the measurement control section 210 supplies a clock CLK1 to a switched capacitor circuit SCC, and controls charging/discharging of the capacitance of the touch electrode TP. Also, the measurement control section 210 sets the thresholds used for the touch determination by the touch determination section 220. Note that the thresholds may be set by an external apparatus including an information processor.

The touch determination section 220 makes the touch determination, based on the measurement value of the capacitance of the touch electrode TP. For example, the touch determination section 220 corresponds to the determination device 1 of FIG. 1. The touch determination section 220 compares the threshold with the difference between the measurement value of the capacitance of the touch electrode TP and a reference value, thereby determining whether the touch electrode is being touched.

As illustrated in FIG. 3, the measurement circuit 110 includes a current mirror circuit 11, a switch circuit 12, a current control oscillating circuit 13, and the counter 14. The configuration of FIG. 3 is exemplary, and the configuration of the measurement circuit 110 is not limited thereto. Note that the switched capacitor circuit SCC is made of a combination of the touch electrode TP and the switch circuit 12.

The current mirror circuit 11 includes a power supply voltage step-down circuit VDC and a p-type transistor Mp12. The power supply voltage step-down circuit VDC steps down a power supply voltage VDD, and generates a voltage VDDR, which is kept at a desired voltage value, in a node NR.

The node NR is connected to the terminal P2. A capacitor C1 is connected to the terminal P2 in order to suppress variation in the voltage VDDR. The terminal P2 is connected to one end of the capacitor C1, and a power supply voltage VSS (also referred to as ground voltage) is applied to the other end thereof. The capacitor C1 may be arranged inside the semiconductor device 100.

The power supply voltage step-down circuit VDC includes a p-type transistor Mp11 and an amplifier AMP. The power supply voltage VDD is applied to a source of the p-type transistor Mp11, and the node NR is connected to a drain thereof. The terminal P3 is connected to one input terminal of the amplifier AMP, and a reference voltage Vref is applied thereto via the terminal P3. A drain voltage of the p-type transistor Mp11 is applied to the other input terminal of the amplifier AMP via the node NR. An output terminal of the amplifier AMP is connected to a gate of the p-type transistor Mp11. The amplifier AMP controls a gate voltage of the p-type transistor Mp11 such that the drain voltage of the p-type transistor Mp11, that is, the voltage of the node NR is equal to the reference voltage Vref. Thereby, the voltage VDDR is generated in the node NR.

The power supply voltage VDD is applied to a source of the p-type transistor Mp12, and the gate of the p-type transistor Mp11 is connected to a gate thereof. That is, the p-type transistor Mp11 and the p-type transistor Mp12 form the current mirror circuit 11. A drain of the p-type transistor Mp12 is connected to the current control oscillating circuit 13. Note that the current driving capability (transistor size) of the p-type transistor Mp11 is set such that a required current I1 can be supplied to the switched capacitor circuit SCC. The current driving capability of the p-type transistor Mp12 is set such that a required current I2 can be supplied to the current control oscillating circuit 13.

The switch circuit 12 includes a switch SW1 and a switch SW2. The node NR for outputting the voltage VDDR is connected to one end of the switch SW1, and a node NS is connected to the other end thereof. The other end of the switch SW1 is connected to one end of the switch SW2 via the node NS, and the power supply voltage VSS is applied to the other end thereof. The node NS is connected to the terminal P1.

The switch SW1 and the switch SW2 complementarily change between a conduction state (ON state) and a non-conduction state (OFF state) in response to the clock CLK1. For example, in a period of the clock CLK1 at low level, the switch SW1 is set to the conduction state while the switch SW2 is set to the non-conduction state. In a period of the clock CLK1 at high level, the switch SW1 is set to the non-conduction state while the switch SW2 is set to the conduction state. Thus, in the period of the clock CLK1 at low level, to the terminal P1, the switch SW1 applies the voltage VDDR output from the power supply voltage step-down circuit VDC. In the period of the clock CLK1 at high level, the switch SW2 applies the power supply voltage VSS to the terminal P1. As can be seen from the change in the logic level of the clock CLK1 and the complementary change between the conduction state and the non-conduction state of the switch SW1 and the switch SW2, the switch circuit 12 performs the same operations as those of a CMOS inverter circuit.

The touch electrode TP connected to the terminal P1 functions as one electrode of each of a parasitic capacitor Cs and a parasitic capacitor Cf. The other electrode of the parasitic capacitor Cs corresponds to a ground wiring or the like (not illustrated) of a printed wiring board formed around the touch electrode TP. The other electrode of the parasitic capacitor Cf corresponds to the finger FNG or a human body (not illustrated). A voltage of the other electrode of each of the parasitic capacitor Cs and the parasitic capacitor Cf is set to the ground voltage via the ground wiring, the finger FNG, and the like. The shorter the distance between the touch electrode TP and the finger FNG is, the larger the value of the parasitic capacitor Cf is.

The switched capacitor circuit SCC made of the switch circuit 12 and the touch electrode TP charges and discharges the parasitic capacitor Cs and the parasitic capacitor Cf formed in the touch electrode TP while being in synchronization with the clock CLK1. In the period of the clock CLK1 at low level, the switch circuit 12 applies the voltage VDDR to the touch electrode TP via the terminal P1, and charges the parasitic capacitor Cs and the parasitic capacitor Cf. In the period of the clock CLK1 at high level, the switch circuit 12 applies the power supply voltage VSS to the touch electrode TP via the terminal P1, and discharges the parasitic capacitor Cs and the parasitic capacitor Cf.

The current I1 supplied to the switched capacitor circuit SCC is a current, a value of which is obtained by dividing the value of the voltage VDDR by a value of an equivalent resistance of the switched capacitor circuit SCC. The equivalent resistance of the switched capacitor circuit SCC varies depending on the distance between the finger FNG and the touch electrode TP. Thus, when the finger FNG is touching the touch electrode TP (the touch state), the value of the equivalent resistance of the switched capacitor circuit SCC is decreased while the current I1 is increased by increase in the value of the parasitic capacitor Cf. To the contrary, when the finger FNG is away from the touch electrode TP (the non-touch state), the value of the equivalent resistance of the switched capacitor circuit SCC is increased while the current I1 is decreased by decrease in the value of the parasitic capacitor Cf.

The current control oscillating circuit 13 generates a clock CLK2 whose frequency varies depending on the value of the current I2 output from the current mirror circuit 11. The more the output current I2 is, the higher the frequency of the clock CLK2 is. To the contrary, the less the output current I2 is, the lower the frequency of the clock CLK2 is. The counter 14 outputs the count Nc2 of the clock CLK2 counted at appropriately-set count time.

When the finger FNG is touching the touch electrode TP (the touch state), the value of the current I1 output from the power supply voltage step-down circuit VDC increases, and the value of the current I2 output from the current mirror circuit 11 also increases. When the finger FNG is away from the touch electrode TP (the non-touch state), the value of the current I1 decreases, and the value of the current I2 also decreases. The change in the value of the current I2 depends on the change in the parasitic capacitor Cf in the touch electrode TP. That is, it can be also said that the count Nc2 (the measurement value of the current I2 corresponding to the current I1) counted by the counter 14 is the measurement value of the capacitance of the touch electrode TP. Thus, it can be detected whether the finger FNG is touching the touch electrode TP (to make the touch determination), by detecting the change in the count Nc2 at the set count time and comparing it with the predetermined reference count.

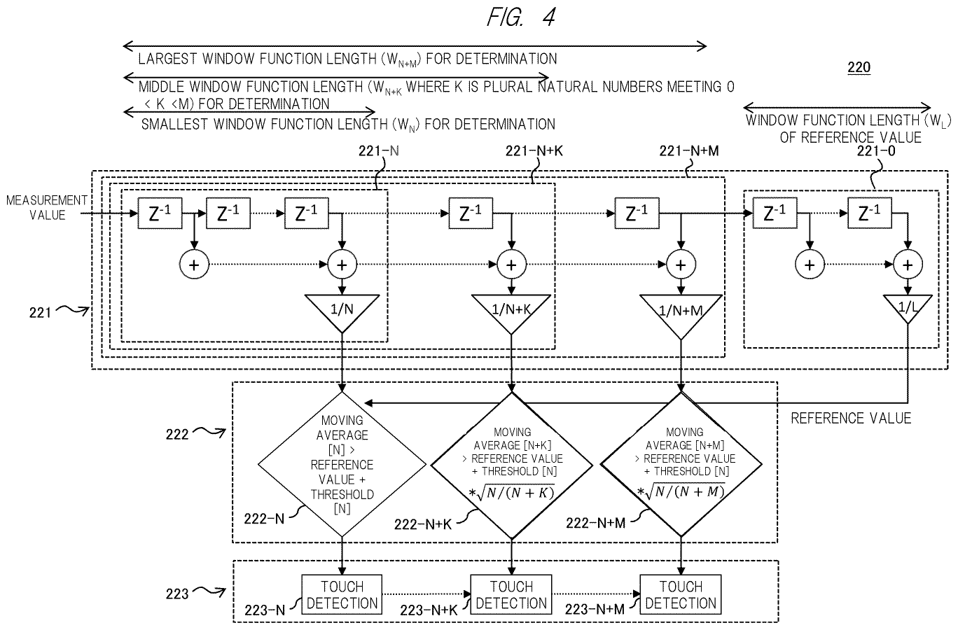

FIG. 4 illustrates an exemplary configuration of the touch determination section 220 included in the control section 200 according to the present embodiment.

The touch determination section 220 makes the touch determination based on the measurement value (the count Nc2) of the capacitance of the touch electrode TP. In the present embodiment, the touch determination section 220 processes the raw data of the measurement value by using the digital filters with the plurality of window function lengths (window sizes) at the same time, and finds the output value thereof. The digital filter may be a moving average filter, a finite impulse response (FIR) filter, an infinite impulse response (IIR) filter, or the like. The touch determination section 220 sets a different threshold for each window function length, and detects the touch state, based on whether the output value of each digital filter exceeds its threshold.

The longer the window function of the digital filter is, the smaller the threshold is. Intervals between the thresholds may not be particularly equal. For example, the touch determination is made by finding the output values of “M+1” digital filters while setting the smallest window function length of to “N” and setting the largest window function length to “N+M”. However, it is not always to use all filters with middle window function length, and some of them may be thinned.

A filter with a longer window function causes a side effect in which the denoising performance is high but the delay amount is large. Thus, when the touch electrode is being touched during a short time, the touch may be detected even after the finger is already away from the electrode. In order to prevent this, if the touch is detected based on an output of a filter with a shorter window function, touch detection based on an output of a filter with a longer window function is disabled during a certain time.

In the example of FIG. 4, the touch determination section 220 includes a moving average calculation section 221, a measurement value determination section 222, and a determination result output section 223.

The moving average calculation section 221 calculates the moving average of the measurement value (the count Nc2) of the capacitance of the touch electrode TP. The moving average calculation section 221 is an exemplary filter for denoising the measurement value. The moving average calculation section 221 calculates a moving average of the measurement value in order to set the reference value for the touch determination, and calculates a moving average of a determination-target measurement value for the touch determination.

The moving average calculation section 221 includes a plurality of moving average calculation sections 221. For example, the moving average calculation section 221 includes “M+2” moving average calculation sections 221-0 and 221-N to 221-N+M. The moving average calculation sections 221-N to 221-N+M share some calculation processings. The window function is made longer in an order of the moving average calculation sections 221-N, 221-N+1, 221-N+2, . . . , 221-N+M. That is, the number of items of data whose moving average is to be calculated is larger. In other words, the denoising performance is higher, and the delay is larger.

The moving average calculation section 221-0 is a reference value setting section for calculating the moving average of the measurement value and setting the reference value based on the calculated moving average. For example, the window function length of the moving average calculation section 221-0 is “L”. The moving average calculation section 221-0 calculates the moving average of “L” measurement values in the non-touch state in order to set the reference value. In the moving average calculation section 221-0, the moving average result of the L measurement values is set as the reference value in the measurement value determination section 222.

The M+1 moving average calculation sections 221-N to 221-N+M calculate the moving averages of the determination-target measurement values at the time of the touch determination. The moving average calculation sections 221-N to 221-N+M are filters for denoising the measurement values. For example, any of the moving average calculation sections 221-N to 221-N+M corresponds to the first filter 2 and the second filter 3 of FIG. 1. The moving average calculation sections 221-N to 221-N+M are different from one another in the window function length. The moving average calculation sections 221-N to 221-N+M calculate the moving averages of the determination-target measurement values by using each different window function length at the same time. The window function length of the moving average calculation section 221-N is “N (the smallest)”. The window function length of the moving average calculation section 221-N+K is “N+K”. The term “K” is plural natural number meeting a relation “0<K<M”. The window function length of the moving average calculation section 221-N+M is “N+M (the largest)”. That is, the moving average calculation section 221-N outputs the moving average result of N measurement values. The moving average calculation section 221-N+K outputs the moving average result of N+K measurement values. The moving average calculation section 221-N+M outputs the moving average result of N+M measurement values.

The measurement value determination section 222 makes the touch determination based on the moving average results (filtering results) of the determination-target measurement values. The measurement value determination section 222 makes the touch determination by comparing the moving average result of the measurement values with the “reference value+threshold”, based on the comparison result. The reference value is a value set by the moving average calculation section 221-0. When the moving average result of the determination-target measurement values is larger than the “reference value +threshold,” the measurement value determination section 222 determines that the touch electrode is in the touch state. When the moving average result of the determination-target measurement values is smaller than the “reference value +threshold,” the measurement value determination section 222 determines that the touch electrode is in the non-touch state.

The measurement value determination section 222 includes “M+1” measurement value determination sections 222-N to 222-N+M in order to determine the respective moving average results of the M+1 moving average calculation sections 221-N to 221-N+M. For example, any of the measurement value determination sections 222-N to 222-N+M corresponds to the first determination section 4 and the second determination section 5 of FIG. 1. The measurement value determination sections 222-N to 222-N+M use the different threshold for each window function length of the moving average calculation sections 221-N to 221-N+M. The measurement value determination section 222-N compares the moving average result of N measurement values output from the moving average calculation section 221-N with a predetermined threshold. The measurement value determination section 222-N+K compares the moving average result of N+K measurement values output from the moving average calculation section 221-N+K with the following equation:

$$“ Predetermined Threshold * √ N / ( N + K ) ” . \qquad [ Equation 1 ]$$

The measurement value determination section 222-N+M compares the moving average result of N+M measurement values output from the moving average calculation section 221-N+M with the following equation:

$$“ Predetermined Threshold * √ N / ( N + M ) ” . \qquad [ Equation 2 ]$$

The determination result output section 223 outputs the determination result of the measurement value determination section 222. For example, the determination result output section 223 corresponds to the output section 6 of FIG. 1. The determination result output section 223 includes M+1 determination result output sections 223-N to 223-N+M corresponding to the determination results of the M+1 measurement value determination sections 222-N to 222-N+M. Any of the determination result output sections 223-N to 223-N+M outputs the determination result of any of the measurement value determination sections 222-N to 222-N+M.

The determination result output section 223-N outputs the determination result of the measurement value determination section 222-N. When the measurement value determination section 222-N determines that the touch electrode is in the touch state (the touch detection), the determination result output section 223-N outputs the determination result indicating the touch state. In this case, during a certain time, the determination result output section 223-N stops the output (determination) by the determination result output sections 223-N+1 to 223-N+M corresponding to the moving average calculation sections 221-N+1 to 221-N+M with the longer window function than that of the moving average calculation section 221-N, and stops the update of the reference value output from the moving average calculation section 221-0. When the measurement value determination section 222-N+K determines that the touch electrode is in the touch state, the determination result output section 223-N+K outputs the determination result indicating the touch state. In this case, the determination result output section 223-N+K stops the outputs by the determination result output sections 223-N+K+1 to 223-N+M+1 corresponding to the moving average calculation sections 221-N+K+1 to 221-N+M+1 with the longer window function than that of the moving average calculation section 221-N+K. When the measurement value determination section 222-N+M determines that the touch electrode is in the touch state, the determination result output section 223-N+M outputs the determination result indicating the touch state.

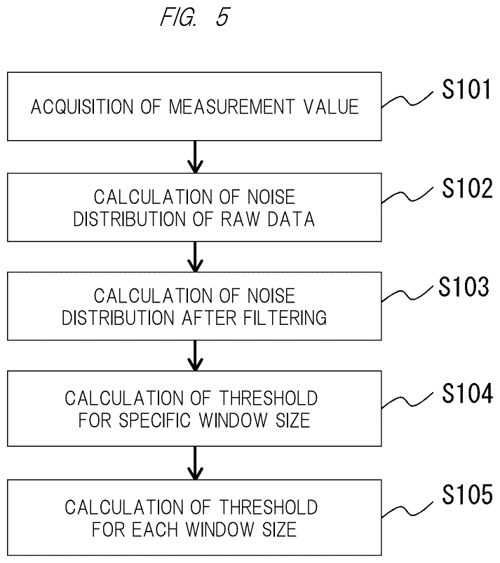

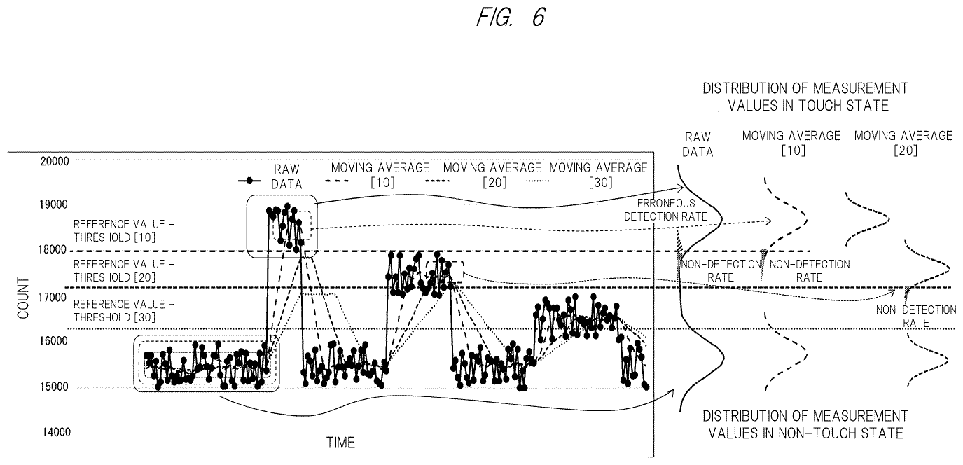

Exemplary thresholds used in the touch determination section 220 according to the present embodiment will be described below with reference to FIG. 5 and FIG. 6.

FIG. 5 illustrates a flow of a method of calculating the threshold set in the touch determination section 220. Each processing in FIG. 5 is performed by, for example, the measurement control section 210, but may be performed by an external apparatus. And, some operations in each processing may be performed by a user.

As illustrated in FIG. 5, the measurement control section 210 acquires the raw data of the measurement value of the touch sensor (S101). The measurement control section 210 acquires a discrete measurement data string (raw data) of the count Nc2 measured by the measurement circuit 110. For example, the measurement control section 210 acquires a discrete measurement data string measured when the touch electrode is not being touched (the non-touch state), or acquires a discrete measurement data string measured when the touch electrode is being touched (the touch state).

Subsequently, the measurement control section 210 calculates noise distribution of the acquired raw data (S102). The measurement control section 210 calculates the noise distribution from the acquired discrete measurement data string (raw data). For example, the noise distribution is assumed as normal distribution, and thus, the mean and the standard deviation of the normal distribution are calculated. For example, the measurement control section 210 calculates the noise distribution of the discrete measurement data string in the non-touch state, and calculates the noise distribution of the discrete measurement data string in the touch state.

Subsequently, the measurement control section 210 calculates the noise distributions acquired after the passage through the noise filters (S103). The filter property (window size) of each of the filters (the moving average calculation sections 221-N to 221-N+M) in the touch determination section 220 is previously set. The measurement control section 210 calculates the noise distributions acquired after the passage through the filters, from the calculated raw-data noise distribution and the filter properties of the filters. For example, the measurement control section 210 calculates the noise distribution acquired after the discrete measurement data string in the non-touch state passes through the filters, and calculates the noise distribution acquired after the discrete measurement data string in the touch state passes the filters.

Subsequently, the measurement control section 210 calculates the threshold for a specific window size (S104). The measurement control section 210 calculates a threshold for determining a value acquired after passage through a filter with the specific window size among the filters. For example, the measurement control section 210 calculates a threshold for the filter (the moving average calculation section 221-N) with the smallest window size.

For example, the measurement control section 210 estimates an erroneous detection rate and a non-detection rate, based on the noise distribution acquired after the passage through the specific filter in the non-touch state and the noise distribution acquired after the passage through the specific filter in the touch state. The erroneous detection rate is a probability at which the touch state is determined in the non-touch state. The non-detection rate is a probability at which the non-touch state is determined in the touch state. The measurement control section 210 calculates the threshold for the specific filter such that the erroneous detection rate and the non-detection rate are at predetermined values. For example, the threshold is calculated to meet relations of “erroneous detection rate=0” and “non-detection rate=1/1000”.

Subsequently, the measurement control section 210 calculates a threshold for each window size (S105). The measurement control section 210 calculates a threshold for the other window size, based on the calculated threshold for the specific window size. For example, the measurement control section 210 calculates the threshold for the filter with the other window size, based on a threshold for a filter with the smallest window size. For example, the filter with the smallest window size is the moving average calculation section 221-N, and the filters with the other window sizes are the moving average calculation sections 221-N+1 to 221-N+M. The measurement control section 210 calculates the threshold for each window size such that the non-detection rate and the erroneous detection rate are the same (or are not large) between the filter with the specific window size and the filters with the other window sizes.

For example, when the noise distribution is the normal distribution while the noise filters are the moving average filters, the erroneous detection rate and the non-detection rate can be calculated from a standard deviation of the noise and a probability density function of the normal distribution. When it is assumed that the window size is “n”, the standard deviation σ[n] of the noise after the filtering is “1/√n” of the standard deviation of the noise of the raw data, and thus, the threshold [n] of each measurement value determination section included in the measurement value determination section 222 is determined in proportion to 1/√n. For example, in the case of the moving average calculation section 222-N+K, the window size of the moving average calculation section 221-N+K is “N+K”, and thus, the threshold [N+K] is set to the following equation:

$$“ Threshold [ N ] * √ N / ( N + K ) ” . \qquad [ Equation 3 ]$$

Note that the coefficient is not limited to 1/√n, and other coefficient may be used in accordance with the noise distribution.

By the measurement control section 210, the calculated threshold for the filter with each window size is set to the measurement value determination section 222 of the touch determination section 220. The touch determination section 220 makes the touch determination by using the set thresholds.

FIG. 6 illustrates an exemplary threshold for the filter with each window size. In the example of FIG. 6, the digital filters are the moving average filters, and the window sizes of the moving average filters are assumed as 10, 20, and 30.

For example, as illustrated in FIG. 6, it is assumed that the noise distribution of the raw data of the measurement values in the touch state and the noise distribution of the raw data of the measurement values in the non-touch state are normal distributions. In the example of FIG. 6, the noise distribution of the raw data of the measurement values in the touch state partially overlaps the noise distribution of the raw data of the measurement values in the non-touch state. Thus, the setting of the thresholds as illustrated in FIG. 6 causes the erroneous detection and the non-detection. That is, when the distribution of the measurement values in the non-touch state is larger than the thresholds, the erroneous detection is caused. When the distribution of the measurement values in the touch state is smaller than the thresholds, the non-detection is caused.

The standard deviations of the noise distribution based on the moving average filter [10] with the window size 10, the noise distribution based on the moving average filter [20] with the window size 20, and the noise distribution (not illustrated) based on the moving average filter with the window size 30 are smaller than that of the noise distribution of the raw data. Thus, the interval between the noise distribution of the raw data of the measurement values in the touch state and the noise distribution of the raw data of the measurement values in the non-touch state is widened by the moving average filter [10], the moving average filter [20], and the moving average filter [30]. Thereby, the non-detection rate can be reduced when the capacitance in the touch state does not change. Also, the distribution of the measurement values in the non-touch state is not larger than the thresholds, the erroneous detection can be prevented. That is, the standard deviation of the noise acquired after the passage through the moving average filter [n] can be set to 1/√n of the standard deviation of the noise of the raw data, and thus, the threshold is set in proportion to 1/√n. For example, when the threshold for the window size 10 is set to the threshold [10], the threshold [20] for the window size 20 is set to the threshold [10]*√(10/20), and the threshold [30] for the window size 30 is set to the threshold [10]*√(10/30). Thereby, the increases in the non-detection rate and the erroneous detection rate can be suppressed, and a touch with a small capacitance change can be also detected.

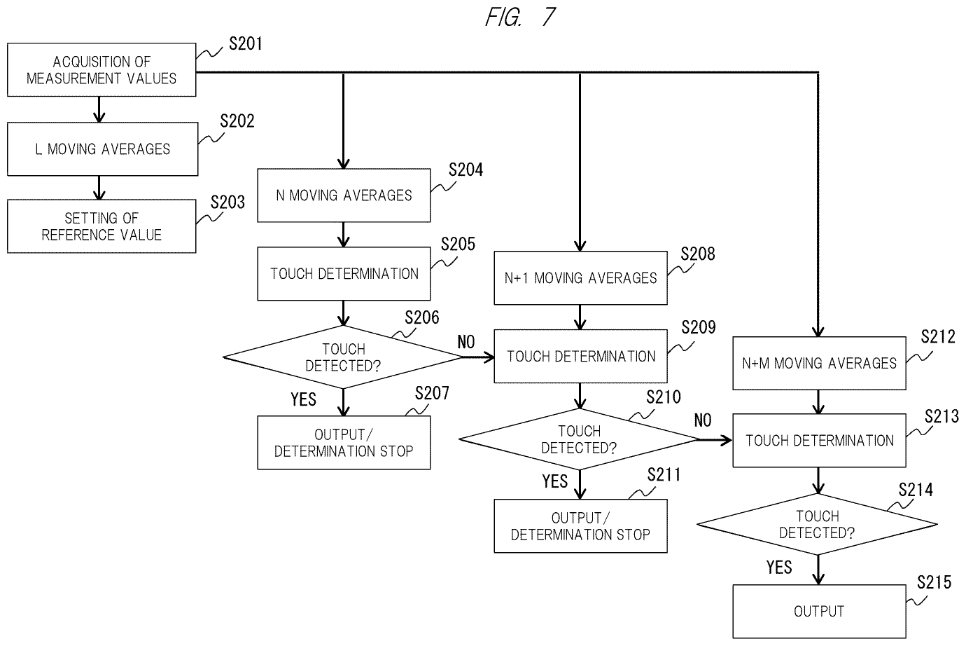

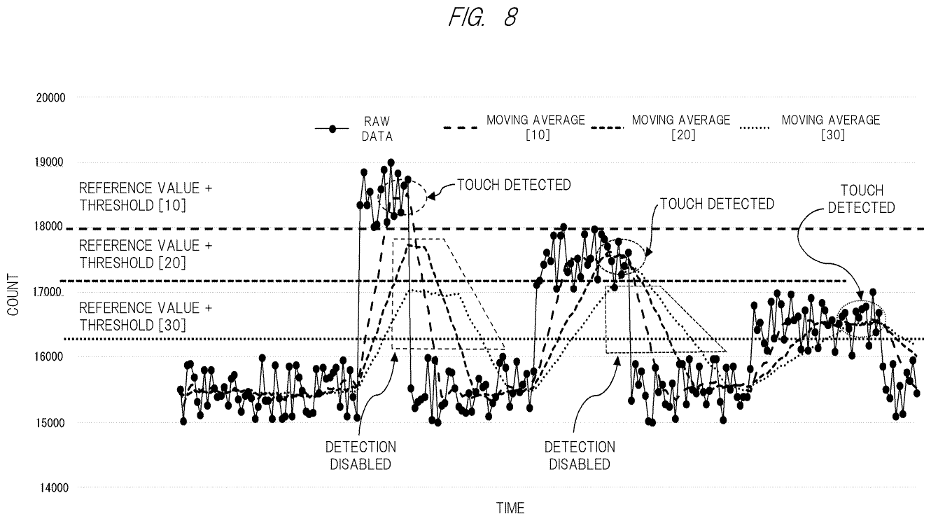

Exemplary touch determination according to the present embodiment will be described with reference to FIG. 7 and FIG. 8. FIG. 7 illustrates a flow of the touch determination in the touch determination section 220.

As illustrated in FIG. 7, the touch determination section 220 acquires the raw data of the measurement values of the touch sensor (S201). The measurement control section 210 acquires the discrete measurement data string (raw data) of the count Nc2 counted by the measurement circuit 110. For example, at the time of the setting of the reference value, the measurement control section 210 acquires the discreate measurement data string measured when the touch electrode is not being touched (the non-touch state). The measurement control section 210 acquires the discreate measurement data string measured as the determination target at the time of the touch determination.

Subsequently, the touch determination section 220 calculates the moving averages from the acquired raw data of the measurement values (S202, S204, S208, S212). Specifically, the moving average calculation section 221-0 calculates the moving average of “L” measurement values in the non-touch state in order to set the reference value (S202). Subsequently, by the moving average calculation section 221-0, the calculated moving average result of the L measurement values is set as the reference value to the measurement value determination section 222 (S203).

The moving average calculation section 221-N calculates the moving average of “N” determination-target measurement values at the time of the touch determination (S204). Subsequently, the measurement value determination section 222-N makes the touch determination by comparing the difference between the calculated moving average result of the N measurement values and the set reference value with the predetermined threshold (S205). The determination result output section 223-N determines whether the touch state is detected (determined), based on the moving average of the N measurement values (S206). When the touch state is detected, the determination result output section 223-N outputs the detection of the touch state (S207). The determination result output section 223-N also stops the outputs from the determination result output sections 223-N+1 to 223-N+M (the determinations made by the measurement value determination sections 222-N+1 to 222-N+M). When the touch state is not detected based on the moving average of the N measurement values, the touch determination is made based on the moving average result of “N+1” measurement values.

The moving average calculation section 221-2 calculates the moving average of the N+1 determination-target measurement values (S208) at the same time with S204. Subsequently, the measurement value determination section 222-N+1 makes the touch determination (S209) by comparing the difference between the calculated moving average result of the N+1 measurement values and the set reference value with the following equation:

$$“ Predetermined Threshold * √ N / ( N + 1 ) ” . \qquad [ Equation 4 ]$$

The determination result output section 223-N+1 determines whether the touch state is detected (determined), based on the moving average of the N+1 measurement values (S210). When the touch state is detected, the determination result output section 223-N+1 outputs the detection of the touch state. The determination result output section 223-N+1 also stops the outputs from the determination result output sections 223-N+2 to 223-N+M (the determination made by the measurement value determination sections 222-N+2 to 222-N+M) (S211). When the touch state is not detected based on the moving average of the N+1 measurement values, the touch determination is made based on the moving average results of “N+2” to “N+M” measurement values. Note that the description for the moving average processing on the “N+2” to “N+M−1” measurement values will be omitted.

The moving average calculation section 221-N+M calculates the moving average of the “N+M” determination-target measurement values (S212) at the same time with S204 and S208. Subsequently, the measurement value determination section 222-N+M makes the touch determination (S213) by comparing the difference between the calculated moving average result of the N+M measurement values and the set reference value with the following equation:

$$“ Predetermined Threshold * √ N / ( N + M ) ” . \qquad [ Equation 5 ]$$

The determination result output section 223-N+M determines whether the touch state is detected (determined) based on the moving average of the N+M measurement values (S214). When the touch state is detected, the determination result output section 223-N+M outputs the determination result (touch detection) (S215).

FIG. 8 illustrates exemplary touch determination made when the threshold for the filter with each window size is set as illustrated in FIG. 6. In the example of FIG. 8, the digital filters are the moving average filters, and the window sizes of the moving average filters are assumed as 10, 20, and 30 as similar to FIG. 6.

As illustrated in FIG. 8, when the noise is larger than the change amount of the raw data of the measurement values, failure of the sufficient denoising by the digital filters causes a risk of the erroneous touch detection. However, it is necessary to increase the window sizes in order to enhance the denoising performance of the digital filters, which leads to an increase in output delay. The large output delay causes a response delay, and causes failure to detect the short touch. In the present embodiment, the touch determination is made by the combination of the plurality of filters with the window functions and the thresholds in order to achieve both the responsiveness and the prevention of the erroneous detection.

In the example of FIG. 8, in the case of the large change amount of the measurement values, the value of the window size 10 acquired after the moving averaging is larger than the threshold [10] for the window size 10. Thus, the touch state is detected based on the threshold [10] while the touch detections based on the outputs of the filters with the window sizes 20 and 30 longer than the window size 10 are temporarily disabled. In the case of the middle change amount of the measurement values, although the value of the window size 10 acquired after the moving averaging is smaller than the threshold [10], the value of the window size 20 acquired after the moving averaging is larger than the threshold [20] for the window size 20. Thus, the touch state is detected based on the threshold [20] while the touch detection based on the output of the filter with the window size 30 longer than the window size 20 is temporarily disabled. In the case of the small change amount of the measurement values because of the light touch, although the values of the window sizes 10 and 20 acquired after the moving averaging are smaller than the thresholds for the window sizes 10 and 20, the value of the window size 30 acquired after the moving averaging is larger than the threshold [30] for the window size 30 if the touch time is long. Thus, the touch state is detected based on the threshold [30].

As described above, in the present embodiment, the touch determination is made by using the plurality of filters with the different window function lengths at the same time to process the measurement values of the touch sensor, and using the different threshold for each window function length. Because of the use of the combination of the plurality of window function lengths and the thresholds, in the case of the large change amount of the measurement values, the touch can be detected with the sufficiently ensured responsiveness. In the case of the small change amount of the measurement values, the touch can be detected with the sufficiently ensured noise tolerance at the expense of responsiveness.

Note that the changes can be detected by not only the touch sensor but also other type of analog sensors in a method similar to that of the present embodiment.

Each of the components illustrated and described as functional blocks for performing various processings may be made of a central processing unit (CPU), a memory, or other circuit in terms of hardware. Each of the components is achieved by a program or the like loaded in a memory in terms of software. Thus, it could be understood by those skilled in the art that such a functional block is achieved as a variety of form by only the hardware, only the software, or a combination thereof, and is not limited to any of them.

The program can be stored by using various types of a non-transitory computer readable medium, and can be provided to the computer. The non-transitory computer readable medium includes various types of a tangible storage medium. Examples of the non-transitory computer readable medium include a magnetic recording medium (such as flexible disc, magnetic tape, hard disc drive) and a magnetooptical recording medium (such as magnetooptical disc). Examples of the non-transitory computer readable medium include a CD-ROM (Read Only Memory), a CD-R, a CD-R/W and a semiconductor memory. Examples of the semiconductor memory include a mask ROM, a PROM (Programmable ROM), an EPROM (Erasable PROM), a flash ROM and a RAM (Random Access Memory). Also, the program may be provided to the computer by various types of a transitory computer readable medium. Examples of the transitory computer readable medium include an electrical signal, an optical signal and an electromagnetic wave. The transitory computer readable medium can provide the program to the computer through a wired communication path such as an electrical wire and an optical fiber or a wireless communication path.

In the foregoing, the invention made by the inventors of the present application has been concretely described based on the embodiments. However, it is needless to say that the present invention is not limited to the foregoing embodiments, and various modifications can be made within the scope of the present invention.

What is claimed is:

1. A determination device comprising:
a first filter configured to perform a first filter processing to a measurement value measured by a sensor, based on a first filter property;
a first determination section configured to determine a detection state of the sensor by comparing a measurement value subjected to the first filter processing with a first threshold;
a second filter configured to perform a second filter processing to the measurement value, based on a second filter property;
a second determination section configured to determine a detection state of the sensor by comparing a measurement value subjected to the second filter processing with a second threshold; and
an output section configured to output a determination result of the first determination section or a determination result of the second determination section.

2. The determination device according to claim 1,
wherein a denoising performance of the second filter is larger than a denoising performance of the first filter, and
wherein the second threshold is smaller than the first threshold.

3. The determination device according to claim 2,
wherein a window size of the second filter is longer than a window size of the first filter.

4. The determination device according to claim 3,
wherein when the window size of the first filter is “n” while the window size of the second filter is “n+m”, the second threshold is 1/√((n+m)/n) of the first threshold.

5. The determination device according to claim 3,
wherein the first filter and the second filter are moving average filters.

6. The determination device according to claim 5,
wherein a part of a moving average processing of the first filter and a part of a moving average processing of the second filter are common.

7. The determination device according to claim 1,
wherein the output section stops outputting a determination result of the second determination section when outputting a determination result of the first determination section.

8. The determination device according to claim 1,
wherein the first determination section compares the measurement value subjected to the first filter processing with a value obtained by adding the first threshold to a reference value, and
wherein the second determination section compares the measurement value subjected to the second filter processing with a value obtained by adding the second threshold to the reference value.

9. The determination device according to claim 8, comprising:
a setting section configured to set the reference value, based on a moving average value of the measurement value measured by the sensor.

10. A determination method comprising steps of:
performing a first filter processing to a measurement value measured by a sensor, based on a first filter property;
determining a detection state of the sensor by comparing a measurement value subjected to the first filter processing with a first threshold;
performing a second filter processing to the measurement value, based on a second filter property;
determining a detection state of the sensor by comparing a measurement value subjected to the second filter processing with a second threshold; and
outputting a determination result based on the first threshold or a determination result based on the second threshold.

11. A determination program for causing a computer to processes of:
performing a first filter processing to a measurement value measured by a sensor, based on a first filter property;
determining a detection state of the sensor by comparing a measurement value subjected to the first filter processing with a first threshold;
performing a second filter processing to the measurement value, based on a second filter property;
determining a detection state of the sensor by comparing a measurement value subjected to the second filter processing with a second threshold; and
outputting a determination result based on the first threshold or a determination result based on the second threshold.
